(19) United States
(12) Patent Application Publication
(10) Pub. No.: US 2007/0013908 A1
(43) Pub. Date: Jan. 18, 2007

(54) Portable raman sensor for soil nutrient detection

(76) Inventors: Won Suk Lee, Gainesville, FL (US); Ismail Bogrekci, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/475,501

(22) Filed: Jun. 27, 2006

Related U.S. Application Data
(60) Provisional application No. 60/694,649, filed on Jun. 28, 2005.

(51) Int. Cl. G01J 3/44; G01N 21/65

(52) U.S. Cl. 356/301

(57) ABSTRACT

An apparatus and method for detecting phosphorus in soil and vegetation are developed. In one embodiment, a portable Raman-based sensor is provided to obtain significant phosphorus absorption band in soils and to determine phosphorus concentrations. The portable sensor can have the capability to measure phosphorus concentrations in wet and dry soil samples as well as fresh and dry vegetations. In one embodiment, the portable sensor of the invention uses a 600 mW laser light source at 785 nm with a full width at half maximum of about 0.2 nm and a spectrometer that covers 340 and 3640 cm⁻¹. Software, written in Visual C++, and partial least squares analysis were used to produce calibration and predictions models.

### CROSS-REFERENCE TO RELATED APPLICATION

This application claims the benefit of provisional patent application Ser. No. 60/694,649, filed Jun. 28, 2005, which is hereby incorporated by reference in its entirety.

### GOVERNMENT SUPPORT

The subject matter of this application has been supported in part by U.S. Government Support under FDACS 006639. Accordingly, the U.S. Government has certain rights in this invention.

### BACKGROUND OF THE INVENTION

Appropriate levels of phosphate are required for aquatic systems to flourish. Phosphate is a valuable nutrient that promotes plant life; sustaining the food chains in ponds, streams, lakes, rivers, estuaries and oceans. Excessive nutrient loads, however, cause algae to proliferate and produce “algal blooms.” The extra algae in the water outcompetes other plant life, absorbs oxygen from the water, and cause eutrophication. As a result, aquatic animals (fish and invertebrates) die and create more phosphate for the algae, intensifying the problem of algal bloom.

Whether or not an algal bloom develops depends on a number of different factors, including flow rates, turbidity, light, salinity and nutrient loads. The most important factor is the amount of phosphorus present. Phosphorus can appear in aquatic systems in three different forms: phosphorus may arrive in a direct soluble form and be used immediately; phosphorus may sink to the bottom as small particles and be released by bacterial action; and/or phosphorus may sink to the bottom and be stored as sediment to become available to plant life at a much later time.

Phosphorus can be introduced to a body of water via at least five different sources: natural sources; existing sediment; sewage and wastewater; animal and human waste; and superphosphate fertilizer. Urban runoff and excessive fertilizer use in modem agriculture is, in part, responsible for the broad-scale, diffuse discharge of phosphorus into lakes and rivers by overland flow and groundwater discharge. For example, nutrient pollution from dairy farms and beef ranches in the Lake Okeechobee (Florida) drainage basin is one of the major problems causing algae blooms and disturbing natural equilibrium in the lake.

Algal bloom (and nutrient pollution) can decrease biotic diversity in local ecosystems by consuming available oxygen reserves and blocking light. It is a problem because it can effectively destroy an environmental niche and make restoration of the area extremely difficult. Moreover, it can pose a risk to human as well as livestock health. For example, livestock deaths have been reported in relation to the consumption of toxic bloom affected water.

Existing methods for determining phosphorus levels in soil/water typically utilize standard chemical and laboratory assessments, which are often costly, time consuming, and labor intensive. For example, laboratory procedures often require collection, preparation, and analysis of soil samples.

Soil reflectance measurements have been used to predict different soil properties. For example, soil reflectance measurements of phosphorus and potassium for different soil orders have been performed (Lee et al., “Estimating chemical properties of Florida soils using spectral reflectance,” Trans. ASAE, 46(5):1443-1453 (2003)), of soil moisture and organic matter (Varvel et al., “Relationship between spectral data from an aerial image and soil organic matter and phosphorus levels,” Precision Agriculture 1:291-300 (1999), and Hummel et al., “Soil moisture and organic matter prediction of surface and subsurface soils using an NIR soil sensor,” Computers and Electronics in Agriculture 32:149-165 (2001)), and of soil mineral nitrogen (Ehsani et al., “A NIR technique for rapid determination of soil mineral nitrogen,” Precision Agriculture 1(2):219-236 (1999)).

Previous studies on sensing phosphorus concentration using ultraviolet (UV), visible (VIS), and near-infrared (NIR) spectroscopy analyzed the combination and overtones of fundamental absorbance bands in the infrared (IR) region. The intensity of absorbance for overtones and combination bands in the UV, VIS, and NIR regions is smaller, however, than that in the IR region, thus making it difficult to accurately assess phosphorus levels. Bogrekci and Lee (“Spectral signatures for the Lake Okeechobee soils using UV-VIS-NIR spectroscopy and predicting phosphorus,” ASAE, Paper No. 041076. St. Joseph, Mich. 2004) investigated possibilities for measuring phosphorus using diffuse reflectance spectroscopy in the UV, VIS, and NIR regions. Unfortunately, use of diffuse reflectance spectroscopy in UV-VIS-NIR produced an approximately 9.4% prediction error using a prediction model with partial least squares. Bogrekci et al., 2003, “Assessment of P-concentration in the Lake Okeechobee Drainage Basins with Spectroscopic Reflectance of VIS and NIR,” ASAE Meeting Paper No. 031139. St. Joseph, Mich.: ASAE.

Raman spectroscopy is an emission technique that uses scattering of incident optical energy to produce spectral peaks that are frequency shifted from the incident optical energy. These so-called Raman emissions are believed to arise from changes in molecule polarization. Virtually all organic molecules display a characteristic Raman emission, including phosphorus. Because these emissions can be linked to a molecule, Raman spectroscopy can be used to analyze a variety of samples to identify molecules of interest, such as phosphorus. To date, phosphorus content in soil has not been analyzed using Raman spectroscopy technology.

Currently, a need exists for systems and methods that rapidly and in a cost efficient manner provide on-site assessment of phosphorus in soil.

### BRIEF SUMMARY OF THE INVENTION

The subject invention provides a portable sensor for remote, in-situ determination of the presence and/or concentration of phosphorus, and other nutrients, in soil in real-time. The portable sensor preferably utilizes Raman spectroscopy technology for detecting and/or quantifying soil-based nutrients in soil, such as phosphorus, nitrogen, potassium, potash, magnesium, sulfur, and other trace vitamins, minerals, and elements. Soil samples can be provided in a variety of forms including solid or slurry. By using Raman spectroscopy, the portable sensor of the invention is able to quickly and accurately detect nutrient levels in soil, preferably phosphorus soil levels, in a cost-effective manner.

The subject sensor is particularly advantageous for use in various applications, such as environmental, agricultural, and scientific applications. For example, the portable sensors of the invention can provide an opportunity to: understand spatial and temporal changes on site; diagnose environmental or crop production management problems; find possible solutions in the field; and manage and restore soil, fields, and farms accordingly.

In a preferred embodiment, the portable sensor of the invention is a portable Raman sensor that comprises a power supply, a laser source, a laser probe, a fiber optic cable, a spectrometer, and a sample compartment. In one embodiment, the sensor has a laser source at 785 nm with a typical full width at half maximum (FWHM) of 0.2 nm and a laser probe assembly with an 1-m optical fiber. The spectral range for measurement of phosphorus is between about 340 and 3640 cm⁻¹.

In one embodiment, the portable sensor of the invention comprises a BTC111E Miniature TE cooled fiber coupled CCD spectrometer (BWTEK Inc. Newark, Del.), SMA 905 fiber coupler (BWTEK Inc. Newark, Del.) for light input with an installed slit of 10 μm, an installed grating, wavelength range 800 to 1150 nm with spectral resolution of about 0.6 nm FWHM (full width at half maximum), built-in 16 bit digitizer, USB 2.0/1.1 interface, 9 ms minimum integration time, and 5V DC power supply.

In certain related embodiments, the portable sensor of the invention further comprises any one or combination of the following: (a) FLA-110 Cylindrical focusing lens assembly (BWTEK Inc. Newark, Del.) for spectrometer throughput improvement of up to >2 times; (b) BRM-785-0.50-100-0.22-SMATurnkey narrow spectral width fiber coupled laser (BWTEK Inc. Newark, Del.), center wavelength 785+/−1 nm, Max. FWHM linewidth 0.3 nm, typical FWHM linewidth 0.2 nm, output power >600-1500 mW, including all driving electronics, fiber coupled via 100 μm @ 0.22 NA fiber in SMA905; and (c) RPA-785-SMA Fiber Raman probe assembly (BWTEK Inc. Newark, Del.) for 785 nm laser, 100 μm at 0.22 NA fiber for excitation, 200 μm @ 0.22 NA for Raman pickup, OD>6, 1 meter fiber length, terminated in SMA905.

In certain embodiments, the portable sensor of the invention further comprises a conventional computer system and/or a means for heating/drying a soil sample. The computer system can include an input means and an output means. The input means provides the user with the ability to interact with the computer system whereas the output means communicates information/data to the user. The computer system preferably has the ability to store programs and data as well as execute computer program instructions. The computer system preferably executes analysis operations on data to determine and/or predict phosphorus concentration. The analysis operations can include software for calculating the predicted phosphorus concentration of the soil sample for future use.

The algorithms utilized in the present invention are particularly advantageous in that they enable the portable phosphorus detection system to provide real-time detection results as well as automatic and real-time identification and/or prediction of phosphorus concentrations in soil.

In one embodiment, the portable sensor also incorporates an intelligence means, such as a neural network system, that utilizes the collected data to analyze and interpret trends in phosphorus concentrations. The intelligence means can also offer advice including, but not limited to, options for addressing phosphorus levels, possibility for algal bloom, characteristic of the phosphorus (such as organic, inorganic, loosely bound, alkali-extractable organic, and residual organic phosphorus), etc.

This subject portable sensor system can also comprise a spectral database and/or a Global Positioning System (GPS) receiver. Spectral signatures of soils in investigated areas can be obtained from the spectral database where location and/or spectral information are kept. In certain embodiments, phosphorus data obtained for soil samples can be linked with sample location identified via GPS. Therefore, spectral signatures of soil without any nutrients and organic matter in certain locations can be used for further computations.

A method for detecting nutrients in soil (such as phosphorus, nitrogen, potassium, potash, magnesium, sulfur, and other trace vitamins, minerals, and elements) is also part of the present invention, wherein a sample of soil is placed into a sample compartment. In one embodiment, the sample compartment includes a means for drying, grinding, and/or sieving the soil sample. The soil sample is then analyzed using a laser beam, where the laser beam is reflected and collected through a Raman probe and fiber optic cable by a spectrometer. In one embodiment, the spectrometer measures the Raman spectrum in a wavenumber range of about 350 to 3640 cm⁻¹. The data generated by the spectrometer is then communicated to a processor to calculate soil-nutrient concentration, preferably phosphorus concentration, in the soil sample.

In certain embodiments, different types of wet or dry soils applicable for soil-nutrient detection in accordance with the systems and methods of the invention include, but are not limited to, sand, loam, clay, silt, peat moss, fen soil, chalk soil, quarry, gravel, and limestone soils. In other embodiments, a combination of soil types can be analyzed for different nutrients, preferably phosphorus, in accordance with the subject invention.

### BRIEF DESCRIPTION OF THE FIGURES

FIG. 1 is a diagram of one embodiment of the invention.

FIG. 2 is a prototype of a portable sensor of the invention that is based on Raman spectroscopy.

FIG. 3 is a graphical illustration of actual and predicted phosphorus concentrations for dried and ground soil samples analyzed using a portable sensor of the invention, where the concentrations were calculated using partial least squares analysis.

FIG. 4 is a graphical illustration of actual and predicted phosphorus concentrations for soil samples analyzed using a portable sensor of the invention, where the concentrations were calculated using partial least squares analysis with the wet soils in the calibration data set.

FIG. 5 is a graphical illustration of actual and predicted phosphorus concentrations for soil samples analyzed using a portable sensor of the invention, where the concentrations were calculated using partial least squares analysis with the wet soils in the validation data set.

FIG. 6 is a graphical illustration of prediction program written in Visual C++ programming language.

FIG. 7 is a graphical illustration of vegetation spectra at different P concentrations in mg/kg.

### DETAILED DESCRIPTION OF THE INVENTION

The subject invention provides a portable sensor system for detecting and assessing nutrient concentration (such as phosphorus, nitrogen, potassium, potash, magnesium, sulfur, and other trace vitamins, minerals, and elements) in soil and vegetation. Preferably, the portable sensor system detects and assesses phosphorus concentration in soil and vegetation. The sensor system of the invention comprises Raman spectroscopy technology for analyzing and monitoring in situ the presence of nutrients, preferably phosphorus, in soil. By using Raman spectroscopy, the subject sensor system exhibits high specificity and the timescale for analysis is short.

According to the subject invention, soil-based nutrients can be detected and analyzed from various types of wet or dry soil samples including, but are not limited to, sand, loam, clay, silt, peat moss, fen soil, chalk soil, quarry, gravel, and limestone soils. In certain embodiments, a combination of soil types can be analyzed for different nutrients, preferably phosphorus, in accordance with the subject invention.

In one embodiment, the phosphorus sensing system of the invention comprises: (1) a power supply; (2) a fiber optic cable; (3) a laser source; (4) a laser-probe; (5) a spectrometer; and (6) a sample compartment. In certain embodiments, the portable sensor further comprises a computer and/or a heating and/or sieving means.

In a related embodiment, the system of the invention further includes an intelligence system that can use the data generated by the computing means in offering support/advice for (1) understanding spatial and temporal changes at a site; (2) diagnosing environmental or crop production management problems; (3) finding possible solutions in the field; and (4) managing and restoring soil, field, and farm land. An intelligence system of the subject invention can include, but is not limited to, artificial neural networks, fuzzy logic, evolutionary computation, knowledge-based systems, optimal linear or nonlinear filtering, and artificial intelligence.

In one embodiment, a neural network system is provided in the portable sensor of the invention to enable real-time assistance in providing additional data (i.e., classification of phosphorus compound detected).

In accordance with the subject invention, the computer system comprises a digital signal processor, which can (1) automatically, accurately, and in real-time, extract signals from the spectrometer; (2) assess the quality of data; (3) and determine phosphorus concentration.

Raman Spectroscopy

Raman spectroscopy is the measurement of the wavelength and intensity of inelastically scattered light from molecules. When a beam of light is impinged upon a sample, photons are absorbed by the material and scattered. The vast majority of these scattered photons have exactly the same wavelength as the incident photons (also referred to herein as the Rayleigh scatter), but a tiny portion of the scattered radiation is shifted to a different wavelength (also known as the Raman scatter or Raman effect). Raman scattering can occur with a change in vibrational, rotational, or electronic energy of a molecule. The difference in energy between the incident photon and the Raman scattered photon is equal to the energy of a vibration of the scattering molecule. A plot of intensity of scattered light versus energy difference is a Raman spectrum. Raman spectra are unique to a given compound and hence can be used to “fingerprint” or uniquely identify as well as quantify chemicals on a surface, in a solid, in a liquid, or in air.

A portable Raman sensor of the invention comprises: a power supply; a laser source; a fiber optic cable; a laser probe; a spectrometer; and a sample compartment.

At least one laser is used in accordance with the present invention to excite Raman spectra because it provides a coherent beam of monochromatic light. The laser provides sufficient intensity to produce a useful amount of Raman scatter and allows for clean spectra, free of extraneous bands. Preferably, lasers used in the portable sensor of the invention exhibit good wavelength stability and low background emission. Lasers than can be used with the sensor of the invention include green, red, blue, ultraviolet, or near-infrared lasers. The portable sensor of the invention includes at least one fiber optic cable for communicating between various sensor components, such as between the sample compartment and the spectrometer. In certain embodiments, the fiber optic cable carries the laser source either to be focused on the sample or to the laser probe. Data generated from the scattering process is communicated to either the fiber optic cable or the laser probe. The laser probe is a collection device that collects the scattered photons, filters out the Rayleigh scatter and any background signal from the fiber optic cable(s), and sends the Raman scatter to the spectrometer. In certain embodiments, the probe(s) also focuses and delivers the laser source.

According to the present invention, a spectrometer is used to analyze information provided by the probe. When Raman scattered photons enter the spectrometer, they are passed through a transmission grating to separate them by wavelength and passed to a detector, which records the intensity of the Raman signal at each wavelength. This data is plotted as the Raman spectrum.

Several spectrometer designs are available for use with the portable sensor of the invention. A spectrometer of the invention is selected based on the resolution required, the wavelength range(s) that needs to be captured, stray light treatment, and light throughput capabilities. In one embodiment, a spectrometer of the invention has collimating optics that direct the incoming light onto a grating or prism, which separates it into component wavelengths. The wavelengths are reflected to a focusing mirror or other optic that directs them onto a detector.

A spectrometer of the invention can include a detector with a wide dynamic range, all noise sources at levels below the shot noise, a wide wavelength range, and, high quantum efficiency. In certain embodiments, the detector is a photomultiplier tube. In other embodiments, temperature compensated silicon charge-coupled-device (or CCDs) are used as detectors because of their ability to measure many wavelengths at once, and because they have a large wavelength range (400-1150 nm), large dynamic range, high quantum efficiency, low read noise, and low dark noise.

In related embodiments, to enhance the sensitivity of the subject technology, an intensified charge-coupled-device (ICCD) is used as a detector. The ICCD directly enhances the signal from any incoming laser source. The ICCD can also be “gated,” which means that it can be automatically turned on and off to measure light scattered by the incident laser source. The ICCD also rejects background light and collects more of the Raman-scattered light, therefore enhancing its signal.

The subject portable sensor also includes a sample compartment in which a soil sample is placed for analysis via Raman spectroscopy in accordance with the present invention. In certain embodiments of the invention, no special treatment of the soil sample is necessary. Field trials showed that portable Raman P sensor produced better predictions for the wet soil samples. Measurement can be conducted with both dry and wet soils. In other embodiments, the soil sample may be placed into an aqueous solution to form a slurry and the slurry sample is analyzed. In further embodiments, the sample compartment includes a means for drying, grinding, and/or sieving the soil sample in preparation for analysis.

The drying means is preferably used to remove water content from the soil sample. Certain drying means applicable to the subject invention include, but are not limited to, an oven, heating coils, and the like. Preferably, the drying means is an oven that can provide a temperature of at least 104° C. for at least 24 hour. The grinding means is used to grind up the soil sample. Contemplated grinding means include shredders, mulchers, granulators, and the like. The sieving means is applied to a soil sample to ensure uniform particle size of the soil samples. Contemplated sieves include about 0.1 to 5.0 mm-sieves, preferably 0.6 mm sieves.

In one method of operation, a sample of soil is placed into the sample compartment of a portable sensor of the invention; a laser source is impinged upon the soil sample where photons from the laser source are absorbed by the soil sample and scattered; the scattered light is collected through the probe and fiber optic cable by a spectrometer; and the spectrometer measures the Raman spectrum.

In certain embodiments, where a computer system is provided, methods of operation further comprise: communication of Raman spectrum to a computer system; analysis of Raman spectrum for presence and/or concentration of phosphorus via the computer system; and communication of results to the user from the computer system.

Computer System

As noted above, certain embodiments of the invention comprise a computer system. The computer system of the invention has a central processing unit capable of executing algorithm operations, a memory capacity for storing algorithm operations and data, a user interface device, and an output device. These and other components are connected to interact with each other by one or more buses. In accordance with the subject invention, the computer system can (1) automatically, accurately, and in real-time, extract signals from the spectrometer; (2) assess the quality of data; (3) and determine phosphorus concentration.

The computer system used in accordance with the subject invention can contain at least one user interface device including, but not limited to, a keyboard, stylus, microphone, mouse, speaker, monitor, and printer. Additional user-interface devices contemplated herein include touch screens, strip recorders, joysticks, and rollerballs.

Preferably, the computer system comprises a central processing unit (CPU) having sufficient processing power to perform algorithm operations in accordance with the subject invention. The algorithm operations, including the statistical operations (such as partial least squares analysis), can be embodied in the form of computer processor usable media, such as floppy diskettes, CD-ROMS, zip drives, non-volatile memory, or any other computer-readable storage medium, wherein the computer program code is loaded into and executed by the computer system. Optionally, the operational algorithms of the subject invention can be programmed directly onto the CPU using any appropriate programming language, preferably using the Visual C++ programming language.

In certain embodiments, the computer system comprises a memory capacity sufficiently large to perform algorithm operations in accordance with the subject invention. The memory capacity of the invention can support loading a computer program code via a computer-readable storage media, wherein the program contains the source code to perform the operational algorithms of the subject invention. Optionally, the memory capacity can support directly programming the CPU to perform the operational algorithms of the subject invention. A standard bus configuration can transmit data between the CPU, memory, ports and any communication devices.

In addition, as understood by the skilled artisan, the memory capacity of the computing means can be expanded with additional hardware and with saving data directly onto external mediums including, for example, without limitation, floppy diskettes, zip drives, non-volatile read-only memory (ROM), CD-ROMs, and a volatile random access memory (RAM).

The computer system can further include the necessary hardware and software (also referred to herein as the “output device”) to convert analysis results into an output form readily accessible by the user/technician. For example, without limitation, the output device can include a printer, video monitor, speakers, and the like for communicating analysis results to the user/technician. Further, the output device can also include the necessary software and hardware to receive, route and transfer data to a remote location.

Communication devices such as wireless interfaces, cable modems, satellite links, microwave relays, and traditional telephonic modems can transfer data from a computer system to a remote user via a network. Networks available for transmission of data include, but are not limited to, local area networks, intranets and the open internet. A browser interface, for example, NETSCAPE NAVIGATOR or INTERNET EXPLORER, can be incorporated into communications software to view the transmitted data.

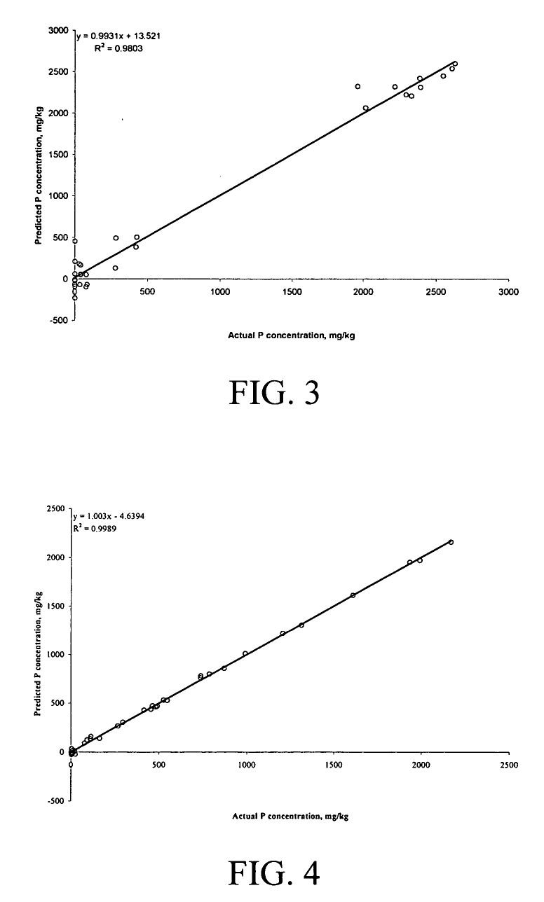

Advantageously, a browser or network interface is incorporated into the processing device to allow the user to view the processed data in a user interface device, for example, a monitor. The results of algorithm operations of the subject invention can be displayed in the form of the interactive graphics, such as those illustrated in FIGS. 3-5. For example, a map or image of the area subject to analysis can be provided to the user. The user can indicate the area from which the soil sample was taken. Graphical representations of the phosphorus content are provided (see FIGS. 3-5) to track the areas of particularly high phosphorus content as well as to track phosphorus concentrations over time.

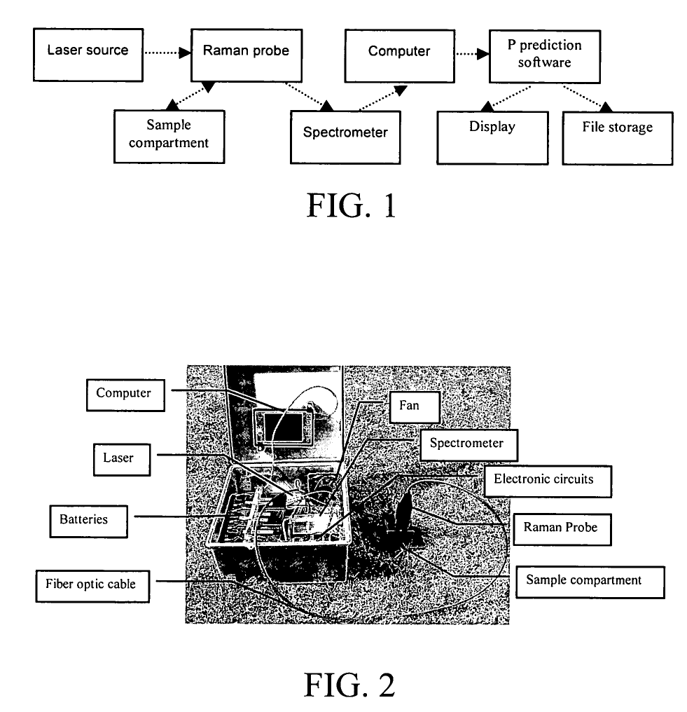

One embodiment of the invention provides a portable phosphorus sensor based on Raman spectrometry. As illustrated in FIG. 1, the portable Raman sensor of the invention can include: a laser source; a Raman probe; a sample compartment; a spectrometer; and a computer system comprising phosphorus prediction software; an output device (such as a monitor); and a memory capacity.

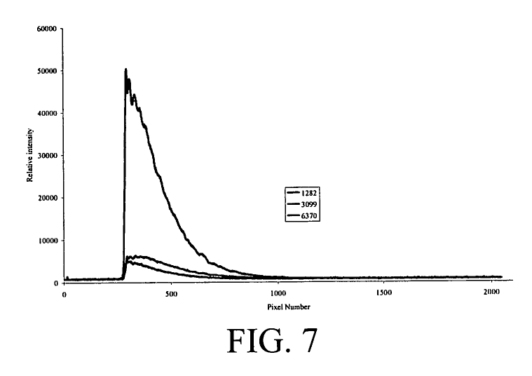

A laser beam, as provided by a portable sensor, is preferably produced at 785 nm or 1064 nm. In certain embodiments, the power range of the laser was preferably at 600-1500 mW. The laser beam illuminates a soil sample in the sample compartment through a fiber optic cable and Raman probe. The reflected light beam is collected through the Raman probe and fiber optic cable by a spectrometer. The spectrometer measures the Raman spectrum. Preferably, the spectrometer measures the Raman spectrum in the wavenumber range of 340 and 3640 cm⁻¹. The Raman spectrum is digitized and the data is sent to a computer through a USB-2 port. A phosphorus prediction program (FIG. 6) written in Visual C++ is used to calculate P concentration of the unknown soil sample using a previously developed prediction model.

Following are examples that illustrate procedures for practicing the invention. These examples should not be construed as limiting. All percentages are by weight and all solvent mixture proportions are by volume unless otherwise noted.

### EXAMPLE 1

### Portable Raman Phosphorus Sensor

In one embodiment, a portable Raman phosphorus sensor comprises the following components: three +12V DC batteries, three power supply regulator circuitries, three switches, a fan, a spectrometer, a laser source, a computer, a Raman probe, and a sample compartment. A depiction of this embodiment is illustrated in FIG. 2.

The power supply circuits provide a 5 V output with 2 A and 4 A, and a 16 V output with 3 A. The switches are used for power I/O control. The fan is used for circulating air in the sensor and keeping the temperature constant. The sample compartment houses a soil sample. The laser source provides a wavelength at 785 nm with a typical full width at half maximum (FWHM) of 0.2 nm. The laser source is coupled with a Raman probe of 1 m length. Light reflected from a soil sample housed in the sample compartment is measured using a TE cooled spectrometer with a spectral range in 340-3640 cm⁻¹.

### EXAMPLE 2

### Analysis of Soil Samples

A portable Raman phosphorus sensor (of Example 1) was used to obtain significant phosphorus absorption band in soils and to determine phosphorus concentrations. Initial laboratory tests were conducted to evaluate the performance of the sensor system. Measured Raman spectra and phosphorus concentration of soils were analyzed using partial least squares (PLS) analysis. PLS results produced the highest R² of 0.98 and root mean square error (RMSE) of 151 mg/kg.

Soil samples from five different fields in the Lake Okeechobee drainage basins were dried at 104° C. for 24 hours and ground & sieved with a 600 μm sieve. A dark current was measured to determine existing electronic noise in the sensing system. Then, a Raman spectrum of the soil sample was measured using the portable sensor of the invention. The dark measurement was subtracted from the Raman spectrum in order to obtain the spectra related to the soil sample itself. A total of 60 soil samples with phosphates concentration ranging from 1-2700 mg/kg were used.

The samples were divided into two as calibration and validation sets. A PLS analysis (Proc PLS, SAS/STAT, SAS Inc.) were used to determine the relationship between Raman spectra and phosphorus concentrations of soils.

Partial least squares prediction results with five factors in the validation data set for actual and predicted phosphorus concentration for the dry soil samples are presented in FIG. 3. Predictions by PLS produced R² of 0.98 with root mean square error (RMSE) of 151 mg/kg. Accordingly, the predicted phosphorus concentration as provided by the portable sensor of the invention is highly accurate.

Field evaluation of the portable sensor of the invention was conducted. The measurements were carried out without any processing of (wet) soil samples. Actual and predicted phosphorus concentration results for the wet soil samples using PLS in the calibration data set for field measurement are shown in FIG. 4. Data was divided into two categories as calibration and validation. The number of factors used to calculate results was five. The range of phosphorus concentration of soil samples was between 2 and 2520 mg/kg.

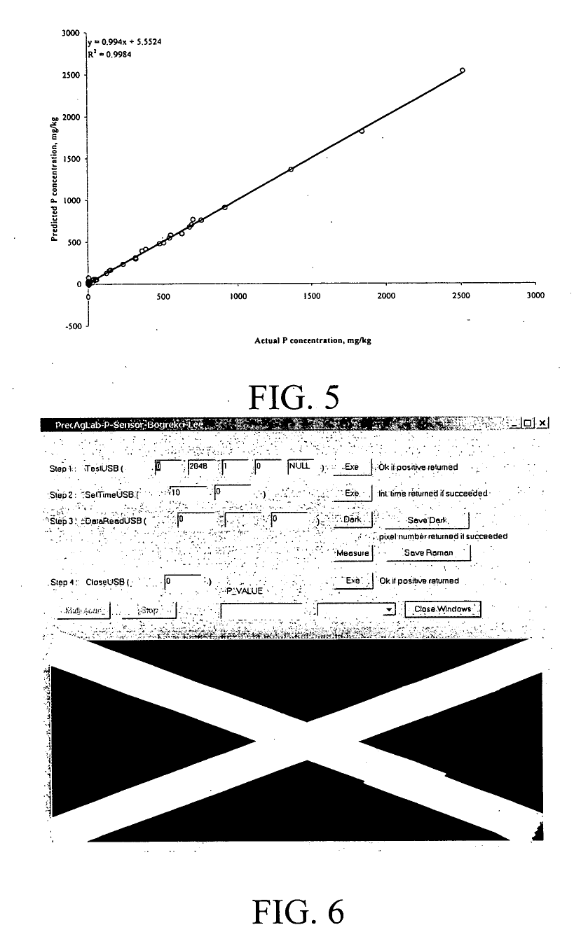

In another experiment, forty samples were used for calibration while another forty samples were used for validation. The calibration produced an R² of 0.9989 with an RMSE of 20.03 mg/kg. Actual and predicted phosphorus concentration results for the wet soil samples using PLS in the validation data set for field measurement are shown in FIG. 5. The predictions produced a very good result with an R² of 0.9984 and RMSE of 21.59 mg/kg. Also vegetation results showed promising results (see FIG. 7).

All patents, patent applications, and publications referred to or cited herein are incorporated by reference in their entirety, including all figures and tables; to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A portable sensor for detecting at least one soil nutrient comprising the following components: a portable power supply; a fiber optic cable; a portable laser source; a portable laser probe; a portable spectrometer; and a sample compartment; wherein said laser source generates at least one signal that is indicative of at least one soil nutrient.

2. The sensor of claim l, wherein the signal generated by the laser source is indicative of at least one soil nutrient selected from the group consisting of: phosphorus, nitrogen, potassium, potash, magnesium, and sulfur.

3. The sensor of claim l, wherein the signal is provided at 785 nm or 1064 nm.

4. The sensor of claim l, wherein the laser source has a power range of at 600-1500 mW.

5. The sensor of claim 1, wherein the spectrometer measures a Raman spectrum in the wavenumber range of 340 and 3640 cm⁻¹.

6. The sensor of claim 1, further comprising a detector to enhance the sensitivity of the sensor.

7. The sensor of claim 6, wherein the detector is an intensified charge-coupled-device (ICCD) that enhances the signal from said laser source.

8. The sensor of claim 6, wherein the ICCD is gated.

9. The sensor of claim 6, wherein the detector is a photomultiplier tube.

10. The sensor of claim 6, wherein the detector is a temperature compensated silicon charge-coupled-device (TE cooled 2048 element linear silicon CCD array).

11. The sensor of claim 1, wherein the laser source is selected from the group consisting of: green, red, blue, ultraviolet, and near-infrared lasers.

12. The sensor of claim 1, wherein said fiber optic cable performs any one or combination of the following functions: (a) communicates between various sensor components; (b) carries the laser source; and (c) communicates data to the laser probe.

13. The sensor of claim 1, wherein said laser probe performs any one or combination of the following functions: (a) collects scattered photons; (b) filters out Rayleigh scatter and any background signals; (c) sends Raman scatter to the spectrometer; and (d) focuses and delivers the laser source.

14. The sensor of claim 1, wherein the spectrometer is used to analyze information provided by the laser probe.

15. The sensor of claim 1, wherein the spectrometer is a BTC111E Miniature TE cooled fiber coupled CCD spectrometer that comprises an installed slit of 10 μm and an installed grating; wherein in the fiber optic cable is a SMA 905 fiber coupler; wherein the grating has a wavelength range 800 to 1150 nm with spectral resolution of about 0.6 nm FWHM (full width at half maximum); wherein the power supply provides 5V DC.

16. The sensor of claim 1, further comprising a built-in 16 bit digitizer and USB 2.0/1.1 interface, 9 ms minimum integration time.

17. The sensor of claim 1, further comprising any one or combination of the following selected from the group consisting of: (a) FLA-110 Cylindrical focusing lens assembly for spectrometer throughput improvement of up to >2 times; (b) BRM-OEM-785-0.50-100-0.22-SMA narrow spectral width fiber coupled laser, center wavelength 785+/−1 nm, Max. FWHM linewidth 0.3 nm, typical FWHM linewidth 0.2 nm, output power >600-1500 mW, including all driving electronics, fiber coupled via 100 μm (0.22 NA fiber in SMA905; and (c) RPA-785-SMA Fiber Raman probe assembly for 785 nm laser, 100 μm at 0.22 NA fiber for excitation, 200 μm @ @ 0.22 NA for Raman pickup, OD>6, 1 meter fiber length, terminated in SMA905.

18. The sensor of claim 1, further comprising a spectral database and/or global position system receiver.

19. A method of soil nutrient detection using a portable sensor comprising a portable power supply; a fiber optic cable; a portable laser source; a portable laser probe; a portable spectrometer; and a sample compartment; said method comprising: a step of supplying a sample to said sample compartment; and a step of detecting the soil nutrient presence in the sample.

20. The method of claim 19, further comprising the steps of (a) using the laser source to illuminate the sample in the sample compartment through a fiber optic cable and Raman probe; (b) collecting the reflected light beam generated from step (a) through the probe and fiber optic cable; and (c) using the spectrometer to measure the Raman spectrum.

21. The method of claim 19, wherein the spectrometer measures the Raman spectrum in the wavenumber range of 340 and 3640 cm⁻¹.

22. A phosphorus detection system comprising:
a portable phosphorus sensor comprising a portable power supply; a fiber optic cable; a portable laser source; a portable laser probe; a portable spectrometer; and a sample compartment; and
a computer system comprising a central processing unit; a user interface device; and an output device, wherein said computer system performs any one or combination of the following: (a) automatically, accurately, and in real-time, extract signals from the spectrometer; (b) assess the quality of signals provided by step (a); (c) and determining phosphorus.

23. The system of claim 22, wherein said central processing unit is capable of executing algorithm operations selected from the group consisting of: partial least squares analysis (PLS) and root mean square (RMSE) analysis.

24. The system of claim 22, wherein said central processing unit is capable of executing algorithm operations that are embodied in any one of the following selected from the group consisting of: floppy diskettes; CD-ROMS; zip drives; and non-volatile memory; wherein the algorithm operations are loaded into and executed by the computer system.

25. The system of claim 22, wherein said central processing unit is capable of executing algorithm operations that are programmed directly onto the central processing unit using a programming language.

26. The system of claim 25, wherein said programming language is Visual C++ programming language.

27. The system of claim 22, wherein said central processing unit further comprises a browser interface.

28. The system of claim 22, wherein said portable phosphorus sensor consists of three +12V DC batteries, three power supply regulator circuitries, three switches, a fan, a spectrometer, a laser source, a Raman probe, and a sample compartment.

29. The system of claim 28, wherein the laser source provides a wavelength at 785 nm with a typical full width at half maximum (FWHM) of 0.2 nm.

30. The system of claim 28, wherein the laser source is coupled with the Raman probe of 1 m length.

31. The system of claim 22, wherein the spectrometer has a spectral range in 340-3640 cm⁻¹.

32. The system of claim 22, further comprising an intelligence system.

33. The system of claim 32, wherein said intelligence system is selected from the group consisting of: artificial neural networks; fuzzy logic; evolutionary computation; knowledge-based systems; optimal linear filtering; nonlinear filtering; and artificial intelligence.

34. The method of claim 19, further comprising the step of sieving the sample prior to supplying the sample to the sample compartment.

35. The method of claim 34, further comprising the step of grinding the sample.

36. The system of claim 22, further comprising a sieving means.

37. The system of claim 22, further comprising a grinding means.
